(19) United States
(12) Patent Application Publication
(10) Pub. No.: US 2017/0015062 A1
(43) Pub. Date: Jan. 19, 2017

(54) APPARATUS AND METHOD FOR ASSEMBLING OUTPUT OF 3D PRINTER

(71) Applicant: ELECTRONICS AND TELECOMMUNICATIONS RESEARCH INSTITUTE, Daejeon (KR)

(72) Inventors: Kap-Kee KIM, Daejeon (KR); Chang-Woo CHU, Daejeon (KR); Chang-Joon PARK, Daejeon (KR); Jin-Sung CHOI, Daejeon (KR)

(21) Appl. No.: 15/083,354

(22) Filed: Mar. 29, 2016

(30) Foreign Application Priority Data
Jul. 14, 2015 (KR) 10-2015-0099541

(51) Int. Cl. B29C 67/00; G06F 17/50

(52) U.S. Cl. CPC B29C 67/0081; G06F 17/50; B29C 67/0085; B33Y 10/00

(57) ABSTRACT

An apparatus and method for assembling 3D printing outputs. The apparatus for assembling 3D printing outputs includes a mesh structuring unit for performing mesh structuring on a segmented surface generated by partitioning a virtual 3D modeled object, a printing unit for selecting the kind and shape of a coupler to be inserted into the segmented surface of the object, modeling a hole in the segmented surface using variables corresponding to the size of the coupler, and printing the partitioned objects, and an assembly unit for inserting the coupler into the hole and assembling the partitioned objects using the coupler.

### CROSS REFERENCE TO RELATED APPLICATION

This application claims the benefit of Korean Patent Application No. 10-2015-0099541, filed Jul. 14, 2015, which is hereby incorporated by reference in its entirety into this application.

### BACKGROUND OF THE INVENTION

1. Technical Field

The present invention relates generally to an apparatus and method for assembling outputs printed from a 3D printer. More particularly, the present invention relates to technology for forming a hole into which a coupler is inserted before outputs are printed and for assembling the outputs using the coupler inserted into the hole.

2. Description of the Related Art

Currently, with regard to a technique for fastening products of a 3D printer, there is provided a method in which a coupler having male and female components is fixed to separate 3D printed objects and the objects are coupled to form a single object using the coupler.

In a 3D modeling phase, a coupler may be shaped whereby a person who models a 3D object specifies the size and location thereof using a basic template or personally designs the coupler. In the case of a template for a coupler, there is a limited number and types thereof, and only templates provided by an authoring and editing tool can be used. Meanwhile, when personally designing a coupler, it takes a lot of time to make the coupler.

Meanwhile, in a phase for fastening 3D printing outputs, separate printed objects are coupled by engaging the male and female components of the coupler, which are fixed to the objects. In this case, it is difficult to assemble and disassemble the objects when the durability of the coupler decreases. Also, due to the low precision of existing printers, the location and size of the connected part may differ from those specified in the 3D modeling phase. Furthermore, because the separate objects may expand or contract during post-processing of the 3D printed object depending on the material and the 3D printing method, it is difficult to fix the coupler to the objects.

Here, in order to connect separately printed objects that use different materials, it is necessary to consider the characteristics of the materials so as to reflect the characteristics on modeling in the modeling phase before the objects are printed. This work is not supported by the authoring/editing tool, and takes a lot of time. Also, because the results of experimentation on the expansion and contraction of various materials are not available, there is no choice but to depend on the experience of designers.

Korean Patent Application Publication No 2014-0061373 discloses a technique for producing toy construction elements for connecting previously manufactured toy components. However, Korean Patent Application Publication No 2014-0061373 discloses only a technique for producing toy construction elements (mainly in the shape of male and female screws) in order to couple toy components in the state in which the toy components to be coupled have been manufactured, but it does not mention anything about determining the part in which to form a groove or factors to be considered in the determination.

### SUMMARY OF THE INVENTION

An object of the present invention is to form a hole into which a coupler is inserted intuitively in a 3D modeling phase.

Another object of the present invention is to insert a coupler into a hole and to assemble objects using the coupler rather than printing an existing coupler to couple the objects.

A further object of the present invention is to assemble objects using a coupler made of magnetic materials.

In order to accomplish the above object, an apparatus for assembling 3D printing outputs includes a mesh structuring unit for performing mesh structuring on a segmented surface that is generated by partitioning a virtual 3D modeled object; a printing unit for selecting a kind and a shape of a coupler to be inserted into the segmented surface of the object, modeling a hole in the segmented surface using variables corresponding to a size of the coupler, and printing partitioned objects; and an assembly unit for fixing the coupler to the hole and assembling the partitioned objects using the coupler.

The printing unit may specify a depth of the hole using variables corresponding to a height of the coupler and specify a width of the hole using variables that correspond to any one of an upper part and a lower part of the coupler.

The printing unit may specify a location at which the hole is to be formed in consideration of the size of the coupler and characteristics of the partitioned objects.

In consideration of a shape of the partitioned objects, the printing unit may designate a point at which binding force between the partitioned objects is largest as the location at which the hole is to be formed, among points distributed on the segmented surface corresponding to the partitioned objects.

The printing unit may convert one side of the partitioned object into a side from which a part that corresponds to the location at which the hole is to be formed and has a size corresponding to the width of the hole is excluded, using a difference operation, and may create a partitioned object having the converted side.

The coupler may be made of a magnetic material.

The printing unit may specify the location of the hole at a point at which the partitioned objects are easiest to couple in consideration of magnetic force of the coupler.

The mesh structuring unit may perform mesh structuring on a segmented surface corresponding to the location of the hole.

The coupler may be any one of a cylinder and a regular hexahedron.

The assembly unit may assemble the partitioned objects using multiple couplers,

Also, a method for assembling 3D printing outputs according to an embodiment of the present invention includes performing mesh structuring on a segmented surface that is generated by partitioning a virtual 3D modeled object; selecting a kind and a shape of a coupler to be inserted into the segmented surface of the object, modeling a hole in the segmented surface using variables corresponding to a size of the coupler, and printing partitioned objects; and inserting the coupler into the hole and assembling the partitioned objects using the coupler.

Printing the partitioned objects may be configured to specify a depth of the hole using variables corresponding to a height of the coupler and to specify a width of the hole using variables that correspond to any one of an upper part and a lower part of the coupler.

Printing the partitioned objects may be configured to specify a location at which the hole is to be formed in consideration of the size of the coupler and characteristics of the partitioned objects.

Printing the partitioned objects may be configured to designate a point at which binding force between the partitioned objects is largest as the location at which the hole is to be formed in consideration of a shape of the partitioned objects, among points distributed on the segmented surface corresponding to the partitioned objects.

Printing the partitioned objects may be configured to convert one side of the partitioned object into a side from which a part that corresponds to the location at which the hole is to be formed and has a size corresponding to the width of the hole is excluded, using a difference operation, and to create a partitioned object having the converted side.

The coupler may be made of a magnetic material.

Printing the partitioned objects may be configured to specify the location of the hole at a point at which the partitioned objects are easiest to couple in consideration of magnetic force of the coupler.

Performing mesh structuring may be configured to perform mesh structuring on a segmented surface corresponding to the location of the hole.

The coupler may be any one of a cylinder and a regular hexahedron.

Assembling the partitioned objects may be configured to assemble the partitioned objects using multiple couplers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for assembling 3D printing outputs according to an embodiment of the present invention;

FIG. 2 is a view illustrating the case in which outputs are assembled using an apparatus for assembling 3D printing outputs according to an embodiment of the present invention;

FIGS. 3 and 4 are views illustrating a coupler that is used in an apparatus for assembling 3D printing outputs according to an embodiment of the present invention, and

FIG. 5 is a flowchart illustrating a method for assembling 3D printing outputs according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment according to an embodiment of the present invention will be described in detail with reference to the accompanying drawings.

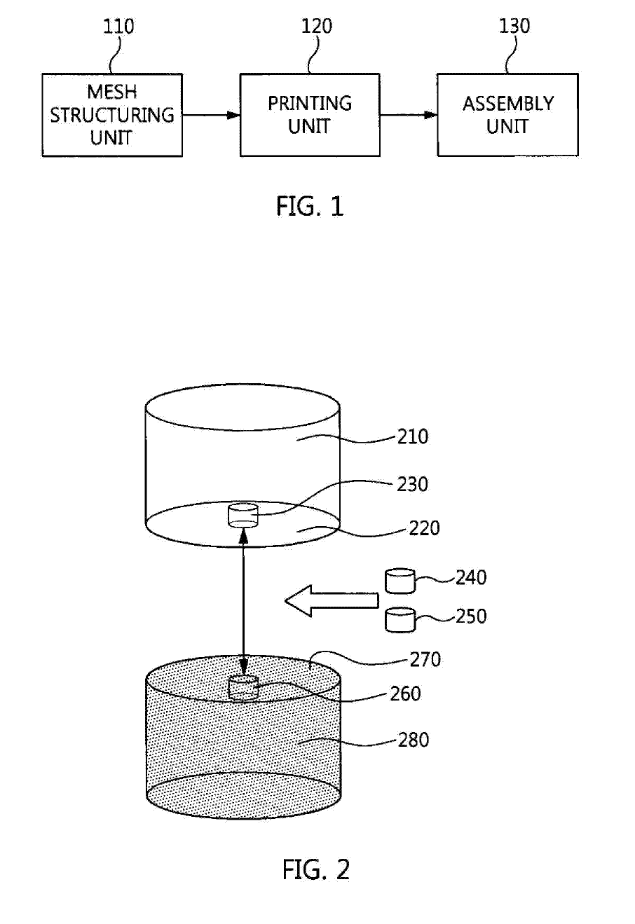

FIG. 1 is a block diagram illustrating an apparatus for assembling 3D printing outputs according to an embodiment of the present invention.

Referring to FIG. 1, an apparatus for assembling 3D printing outputs according to an embodiment of the present invention includes a mesh structuring unit 110, a printing unit 120, and an assembly unit 130.

The mesh structuring unit 110 performs mesh structuring on a segmented surface that is generated by partitioning a virtual 3D modeled object.

Mesh structuring means imparting a segmented surface, which is the surface that appears when partitioning an object, with a mesh structure. Generally, in the case of a virtual 3D modeled object, because virtual modeling is performed only for the outer shape of the object, the inside of the object has an empty state because modeling is not performed. In other words, because the inside of the object is empty when the object is partitioned, the mesh structuring unit 110 generates the segmented surface consisting of a mesh.

Here, the mesh structure is a surface that consists of planar figures. For example, a surface consisting of squares and a surface consisting of regular triangles correspond to a mesh structure.

Here, there is no limitation on the planar figures forming the segmented surface. For example, the segmented surface may be formed with squares or regular triangles.

The printing unit 120 selects the kind and shape of coupler to be inserted into the segmented surface of an object, models a hole in the segmented surface using variables corresponding to the size of the coupler, and prints the partitioned objects.

Here, the coupler may be made of a material that exhibits magnetism. For example, material made of a magnet may be used as a coupler.

In this case, the shape of the coupler is not limited. For example, it may have a cylindrical shape, a cube shape, a rectangular parallelepiped shape, or the like.

The size of the coupler need only be smaller than the size of the partitioned object.

In this case, the variables corresponding to the size of the coupler may include a variable corresponding to the height of the coupler, the width of the underside of the coupler, and the length of the underside of the coupler.

Here, the depth of a hole is specified using the variable corresponding to the height of the coupler, and the width of the hole may be specified using a variable corresponding to any one of the upper part and the lower part of the coupler.

Here, the variable corresponding to the upper part of the coupler may be a variable corresponding to the width of the topside of the coupler or the length of the topside of the coupler.

Also, the variable corresponding to the lower part of the coupler may be a variable corresponding to the width of the underside of the coupler or the length of the underside of the coupler.

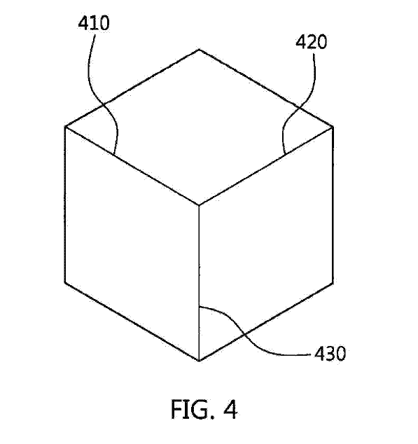

In the case of the coupler in a cylindrical shape, illustrated in FIG. 3, the width of a hole may be specified using a variable 310 corresponding to the radius of the underside (circle) of the cylinder, and the depth of the hole may be specified using a variable 320 corresponding to the height of the cylinder.

In the case of the coupler in a hexahedral shape, illustrated in FIG. 4, the width of a hole may be specified using a variable 410 corresponding to the width of the hexahedron and a variable 420 corresponding to the length of the hexahedron, and the depth of the hole may be specified using a variable 430 corresponding to the height of the hexahedron.

Here, the location at which the hole is formed may be specified in consideration of the characteristics of the coupler and the partitioned object. For example, if the size of the coupler is much smaller than the size of the partitioned object, the binding force increases the closer the hole is located to the center of the segmented surface of the partitioned object. If the hole is located near the edge of the segmented surface, the binding force may decrease. Therefore, the location of the hole may be specified in consideration of the characteristics of the coupler and the partitioned object. As another example, a part of the partitioned object may be designed such that it is weaker than another part. In this case, if the hole is formed in the part that is weaker, when the partitioned object is subjected to an impact, the object may break. Accordingly, the hole needs to be formed in the part that is stronger. According to another embodiment, when a user specifies the location of a hole in consideration of the characteristics of the coupler and the partitioned object and assembles the partitioned objects using the coupler inserted into the hole, if the binding force is lower than a predetermined binding force, the user may decide that the location of the hole is inappropriate.

In this case, in consideration of the magnitude of the magnetic force of the coupler, the printing unit 120 may designate the point at which it is easiest to couple the partitioned objects as the location of the hole. For example, if the magnetic force of the coupler is weak, the binding force may be weak depending on the location of the hole. Accordingly, in consideration of the magnitude of the magnetic force, the point at which it is easiest to couple the partitioned objects may be determined.

Here, the printing unit 120 converts one side of the partitioned object into a side from which a part that corresponds to the location of a hole and has a size corresponding to the width of the hole is excluded, using a difference operation, and then creates a partitioned object having the converted side.

Here, the difference operation comprises specifying the shape of a hole corresponding to the coupler and creating a side from which the specified shape of the hole at the specified location is excluded. The conventional art for modeling a virtual 3D model generates the side from which the hole is excluded at the outset, but the present invention generates a side in which a hole is not formed at first, models a hole, and then generates a segmented surface in which the hole is formed using the difference operation on the previously generated side and the hole. Therefore, a model that includes a hole may be formed more intuitively.

The assembly unit 130 inserts the coupler into the hole in the segmented surface of the partitioned object and assembles the partitioned objects using the coupler.

Here, if there are multiple holes, the assembly unit 130 may assemble the partitioned objects using multiple couplers.

In this case, depending on the material of the partitioned object, the assembly unit 130 may use additional adhesive material to fix the coupler to the partitioned objects.

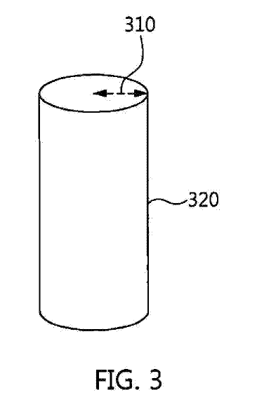

FIG. 2 is a view illustrating the case in which outputs are assembled using an apparatus for assembling 3D printing outputs according to an embodiment of the present invention.

First, mesh structuring is performed on the segmented surfaces, which are generated by partitioning a 3D modeled virtual object (the combination of 210 and 280). Generally, in the ease of a 3D modeled object, because mesh structuring is only performed for the outer shape of the object, a segmented surface, which is in the interior of the object before partitioning, has not been modeled. Therefore, mesh structuring is performed on the segmented surface.

Here, the mesh structure means a surface that consists of planar figures. For example, a surface consisting of squares and a surface consisting of regular triangles correspond to a mesh structure.

In this case, there is no limitation on the planar figures forming the segmented surface. For example, the segmented surface may be formed with squares or regular triangles.

Next, the kind and shape of coupler to be inserted into the segmented surface 220 or 270 of the object may be selected. In FIG. 2, couplers 240 and 250 that have magnetism and a cylindrical shape are selected.

Next, the depth of a hole is specified using a variable corresponding to the height of the coupler 240, and the width of the hole is specified using a variable corresponding to any one of the upper part and the lower part of the coupler 240. In FIG. 2, the width of the hole may be set using a variable corresponding to the radius of the coupler 240 or 250, and the depth of the hole may be set using a variable corresponding to the height of the coupler 240 or 250.

Next, the location of the hole is specified. The location of the hole may be specified by a user, or may be automatically set depending on the characteristics of the coupler or the characteristics of the partitioned object.

Next, the hole 230 or 260 corresponding to the specified location, width, and depth is formed using a difference operation.

Here, the difference operation comprises specifying the shape of a hole corresponding to the coupler and creating a side from which the specified shape of a hole at the specified location is excluded. The present invention generates a side in which a hole is not formed at first, models the hole, and then generates a segmented surface in which the hole is formed using a difference operation on the previously generated side and the hole.

In FIG. 2, the hole 230 or 260 corresponding to the specified location, width, and depth is formed in the segmented surface 220 or 270.

Here, because mesh structuring is not performed on the side surface of the formed hole 230 or 260, a virtual surface may be created thereon by additionally performing mesh structuring.

Next, partitioned objects in which holes are formed are printed. Here, the partitioned objects may be printed using an existing 3D printer.

Next, the coupler 240 or 250 is inserted into the hole 230 or 260 in the partitioned object, and the partitioned objects are assembled.

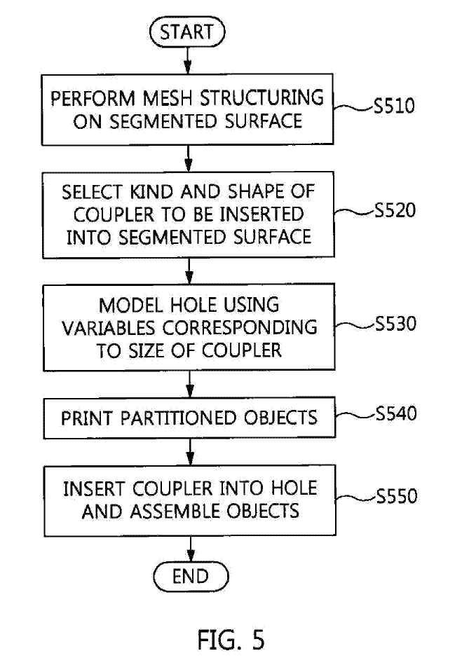

FIG. 5 is a flowchart illustrating a method for assembling 3D printing outputs according to an embodiment of the present invention.

First, the mesh structuring unit 110 performs mesh structuring on a segmented surface that is generated by partitioning a virtual 3D modeled object at step S510.

Mesh structuring is imparting a segmented surface, which is the surface that appears when partitioning an object, with a mesh structure. Generally, in the case of a virtual 3D modeled object, because virtual modeling is performed only on the outer shape of the object, the inside of the object has an empty state because modeling is not performed. In other words, because the inside of the object is empty when the object is partitioned, the mesh structuring unit 110 generates the segmented surface consisting of a mesh.

Here, the mesh structure is a surface that consists of planar figures. For example, a surface consisting of squares and a surface consisting of regular triangles correspond to a mesh structure.

In this case, there is no limitation on the planar figures forming the segmented surface. For example, the segmented surface may be formed with squares or regular triangles.

Also, at step S520, the printing unit 120 selects the kind and shape of coupler to be inserted into the segmented surface.

Here, the coupler may be a material that exhibits magnetism. For example, material made of a magnet may be used as a coupler.

In this case, there is no limitation as to the shape of the coupler. For example, it may have a cylindrical shape, a cube shape, a rectangular parallelepiped shape, or the like.

Also, the printing unit 120 models a hole using variables corresponding to the size of the coupler at step S530.

Here, the size of the coupler need only be smaller than the size of the partitioned object.

In this case, the variables corresponding to the size of the coupler may include a variable corresponding to the height of the coupler, the width of the underside of the coupler, and the length of the underside of the coupler.

Here, the depth of a hole is specified using the variable corresponding to the height of the coupler, and the width of the hole may be specified using a variable corresponding to any one of the upper part and the lower part of the coupler.

Here, the variable corresponding to the upper part of the coupler may be a variable corresponding to the width of the topside of the coupler or the length of the topside of the coupler.

Also, the variable corresponding to the lower part of the coupler may be a variable corresponding to the width of the underside of the coupler or the length of the underside of the coupler.

In the case of a coupler having a cylindrical shape, as illustrated in FIG. 3, the width of a hole may be specified using a variable 310 corresponding to the radius of the underside (circle) of the cylinder, and the depth of the hole may be specified using a variable 320 corresponding to the height of the cylinder.

In the case of a coupler having a hexahedral shape, as illustrated in FIG. 4, the width of the hole may be specified using a variable 410 corresponding to the width of the hexahedron and a variable 420 corresponding to the length of the hexahedron, and the depth of the hole may be specified using a variable 430 corresponding to the height of the hexahedron.

Here, the location at which the hole is formed may be specified in consideration of the characteristics of the coupler and the partitioned object. For example, if the size of the coupler is much smaller than the size of the partitioned object, the binding force increases the closer the hole is located to the center of the segmented surface of the partitioned object. If the hole is located near the edge of the segmented surface, the binding force may decrease. Therefore, the location of the hole may be specified in consideration of the characteristics of the coupler and the partitioned object. As another example, a part of the partitioned object may be designed such that it is weaker than another part. In this case, if the hole is formed in the part that has lower strength, when the partitioned object is subjected to an impact the object may break. Accordingly, the hole needs to be formed in the part that has higher strength. According to another embodiment, when a user specifies the location of a hole in consideration of the characteristics of the coupler and the partitioned object and assembles the partitioned objects using the coupler inserted into the hole, if the binding force is lower than a predetermined binding force, the user may decide that the location of the hole is inappropriate.

In this case, in consideration of the magnitude of the magnetic force of the coupler, the printing unit 120 may designate the point at which the partitioned objects are easiest to couple as the location of the hole. For example, if the magnetic force of the coupler is weak, the binding force may be weak depending on the location of the hole. Accordingly, the point at which the partitioned objects are easiest to couple may be determined in consideration of the magnitude of the magnetic force.

Here, the printing unit 120 converts one side of a partitioned object into a side from which a part that corresponds to the location of the hole and has a size corresponding to the width of the hole is excluded, using a difference operation, and then creates a partitioned object having the converted side.

Here, the difference operation comprises specifying the shape of a hole corresponding to the coupler and creating a side from which the specified shape of a hole at the specified location is excluded. The conventional art for modeling a virtual 3D model generates a side from which a hole is excluded at the outset, but the present invention generates a side in which a hole is not formed at first, models the hole, and then generates a segmented surface in which the hole is formed using a difference operation on the previously generated side and the hole. Therefore, a model that includes a hole may be formed more intuitively.

Also, the printing unit 120 prints the partitioned objects at step S540.

In this case, a 3D printer may be used to print the partitioned objects.

Also the assembly unit 130 inserts the coupler into the hole and assembles the partitioned objects at step S550.

Here, if there are multiple holes, the assembly unit 130 may assemble the partitioned objects using multiple couplers.

In this case, depending on the material of the partitioned object, the assembly unit 130 may use additional adhesive material to fix the coupler to the partitioned objects.

The present invention may form a hole into which a coupler is inserted using an intuitive difference operation in a 3D modeling phase.

Also, the present invention may easily assemble partitioned objects using a method in which a coupler is inserted into a hole to fasten the objects, rather than printing an existing coupler to couple the objects.

Also, the present invention assembles objects using a coupler made of magnetic materials, whereby the objects may be securely and simply assembled.

As described above, an apparatus and a method for assembling 3D printed outputs according to the present invention are not limitedly applied to the configurations and operations of the above-described embodiments, but all or some of the embodiments may be selectively combined and configured, so that the embodiments may be modified in various ways.

What is claimed is:

1. An apparatus for assembling 3D printing outputs, comprising:
a mesh structuring unit for performing mesh structuring on a segmented surface that is generated by partitioning a virtual 3D modeled object;
a printing unit for selecting a kind and a shape of a coupler to be inserted into the segmented surface of the object, modeling a hole in the segmented surface using variables corresponding to a size of the coupler, and printing partitioned objects; and
an assembly unit for fixing the coupler to the hole and assembling the partitioned objects using the coupler.

2. The apparatus of claim 1, wherein the printing unit specifies a depth of the hole using variables corresponding to a height of the coupler and specifies a width of the hole using variables that correspond to any one of an upper part and a lower part of the coupler.

3. The apparatus of claim 2, wherein the printing unit specifies a location at which the hole is to be formed in consideration of the size of the coupler and characteristics of the partitioned objects.

4. The apparatus of claim 3, wherein, in consideration of a shape of the partitioned objects, the printing unit designates a point at which binding force between the partitioned objects is largest as the location at which the hole is to be formed, among points distributed on the segmented surface corresponding to the partitioned objects.

5. The apparatus of claim 4, wherein the printing unit is configured to:
convert one side of the partitioned object into a side from which a part that corresponds to the location at which the hole is to be formed and has a size corresponding to the width of the hole is excluded, using a difference operation; and
creates a partitioned object having the converted side.

6. The apparatus of claim 5, wherein the coupler is made of a magnetic material.

7. The apparatus of claim 6, wherein the printing unit specifies the location of the hole at a point at which the partitioned objects are easiest to couple in consideration of magnetic force of the coupler.

8. The apparatus of claim 7, wherein the mesh structuring unit performs mesh structuring on a segmented surface corresponding to the location of the hole.

9. The apparatus of claim 8, wherein the coupler is any one of a cylinder and a regular hexahedron.

10. The apparatus of claim 9, wherein the assembly unit assembles the partitioned objects using multiple couplers.

11. A method for assembling 3D printing outputs, comprising:
performing mesh structuring on a segmented surface that is generated by partitioning a virtual 3D modeled object,
selecting a kind and a shape of a coupler to be inserted into the segmented surface of the object, modeling a hole in the segmented surface using variables corresponding to a size of the coupler, and printing partitioned objects; and
inserting the coupler into the hole and assembling the partitioned objects using the coupler.

12. The method of claim 11, wherein printing the partitioned objects is configured to:
specify a depth of the hole using variables corresponding to a height of the coupler; and
specify a width of the hole using variables that correspond to any one of an upper part and a lower part of the coupler.

13. The method of claim 12, wherein printing the partitioned objects is configured to specify a location at which the hole is to be formed in consideration of the size of the coupler and characteristics of the partitioned objects.

14. The method of claim 13, wherein printing the partitioned objects is configured to designate a point at which binding force between the partitioned objects is largest as the location at which the hole is to be formed in consideration of a shape of the partitioned objects, among points distributed on the segmented surface corresponding to the partitioned objects.

15. The method of claim 14, wherein printing the partitioned objects is configured to:
convert one side of the partitioned abject into a side from which a part that corresponds to the location at which the hole is to be formed and has a size corresponding to the width of the hole is excluded, using a difference operation; and
create a partitioned object having the converted side.

16. The method of claim 15, wherein the coupler is made of a magnetic material.

17. The method of claim 16, wherein printing the partitioned objects is configured to specify the location of the hole at a point at which the partitioned objects are easiest to couple in consideration of magnetic force of the coupler.

18. The method of claim 17, wherein performing mesh structuring is configured to perform mesh structuring on a segmented surface corresponding to the location of the hole.

19. The method of claim 18, wherein the coupler is any one of a cylinder and a regular hexahedron.

20. The method of claim 19, wherein assembling the partitioned objects is configured to assemble the partitioned objects using multiple couplers.
